(19) United States
(12) Patent Application Publication
(10) Pub. No.: US 2026/0282028 A1
(43) Pub. Date: Sep. 17, 2026

(54) PDCCH MONITORING FOR TXRU CARRIER SWITCH FOR B5G/6G

(71) Applicant: MEDIATEK INC., Hsinchu City (TW)

(72) Inventors: Yi-Ju LIAO, Hsinchu City (TW); Pei-Kai LIAO, Hsinchu City (TW); Chi-Hsuan HSIEH, Hsinchu City (TW)

(73) Assignee: MEDIATEK INC., Hsinchu City (TW)

(21) Appl. No.: 19/473,279

(22) PCT Filed: Aug. 23, 2024
(86) PCT No.: PCT/CN2024/114088

§ 371 Date: Oct. 7, 2025

Related U.S. Application Data
(60) Provisional application No. 63/578,399, filed on Aug. 24, 2023.

(51) Int. Cl. H04W 72/23; H04L 1/00

(52) U.S. Cl. CPC H04W 72/23; H04L 1/0061

(57) ABSTRACT

In an aspect of the disclosure, a method, a computer-readable medium, and an apparatus are provided. The apparatus may be a UE. The UE receives an indication indicative of a monitoring method for a PDCCH and a carrier switch method from a base station. The UE determines, based on the indication, the monitoring method for the PDCCH and the carrier switch method. The UE performs PDCCH monitoring and carrier switch, based on the monitoring method for the PDCCH monitoring and the carrier switch method.

### CROSS-REFERENCE TO RELATED APPLICATION(S)

This application claims the benefit of U.S. Provisional Application Ser. No. 63/578,399, entitled “PDCCH MONITORING FOR TXRU CARRIER SWITCH FOR B5G/6G” and filed on Aug. 24, 2023, which is expressly incorporated by reference herein in its entirety.

### BACKGROUND

### Field

The present disclosure relates generally to wireless communications, and more particularly, to techniques of managing Physical Downlink Control Channel (PDCCH) monitoring in carrier switch scenarios.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives an indication indicative of a monitoring method for a PDCCH and a carrier switch method from a base station. The UE determines, based on the indication, the monitoring method for the PDCCH and the carrier switch method. The UE performs PDCCH monitoring and carrier switch, based on the monitoring method for the PDCCH monitoring and the carrier switch method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a wireless communication system.

FIG. 8 is a diagram illustrating an improved result of an agile carrier switch.

FIG. 9 is a diagram illustrating an example of canceling a receive unit (RxU) switch.

FIG. 10 illustrates a flow chart of a process for managing PDCCH monitoring in carrier switch scenarios.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

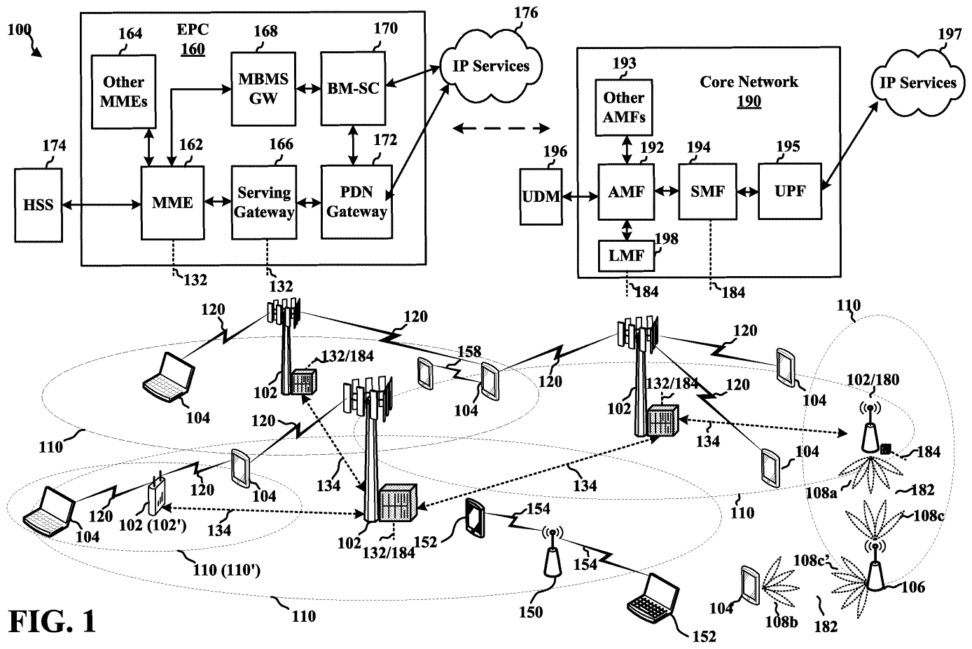

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mm W or near mm W frequencies, the gNB 180 may be referred to as an mm W base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

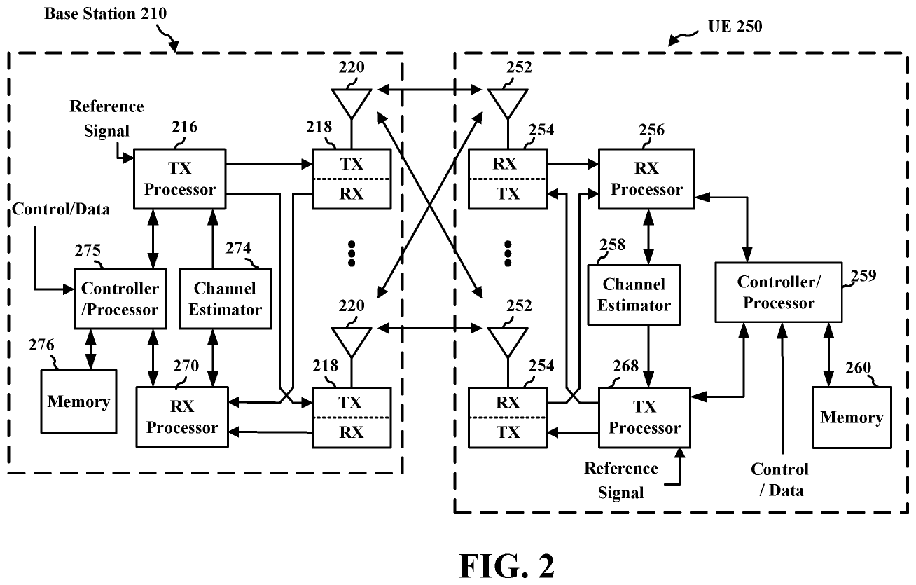

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

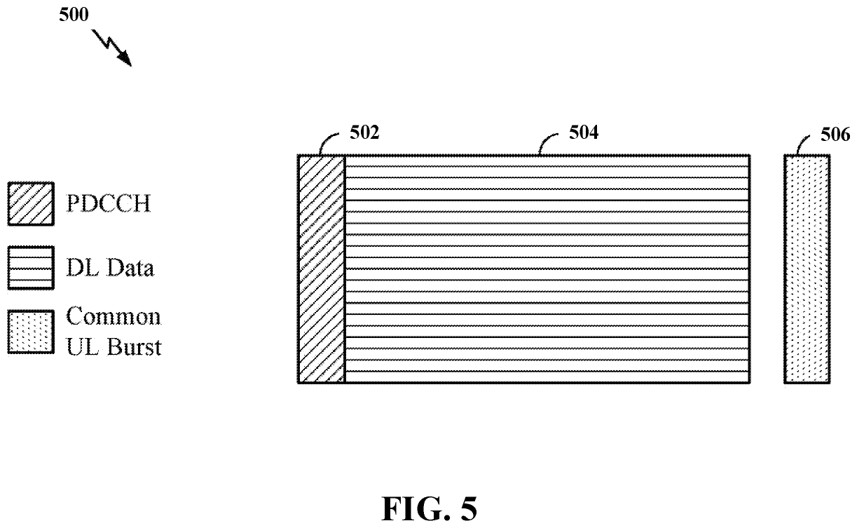

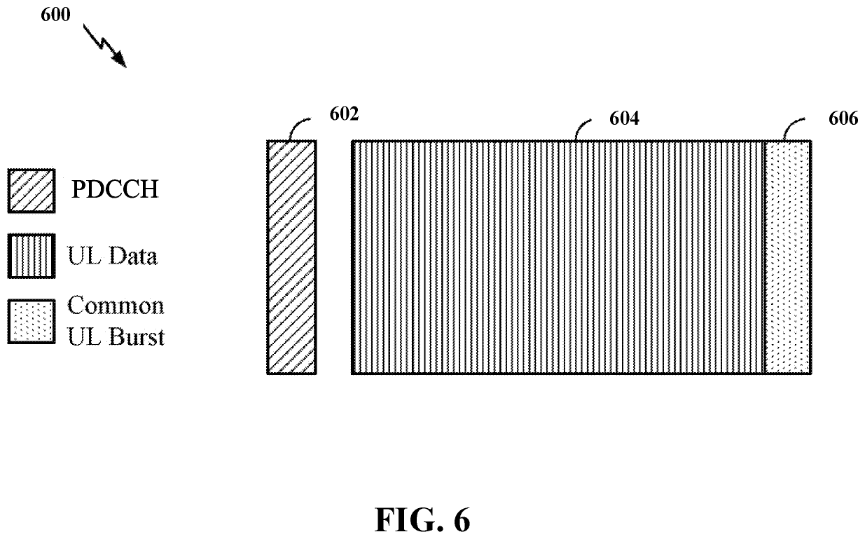

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

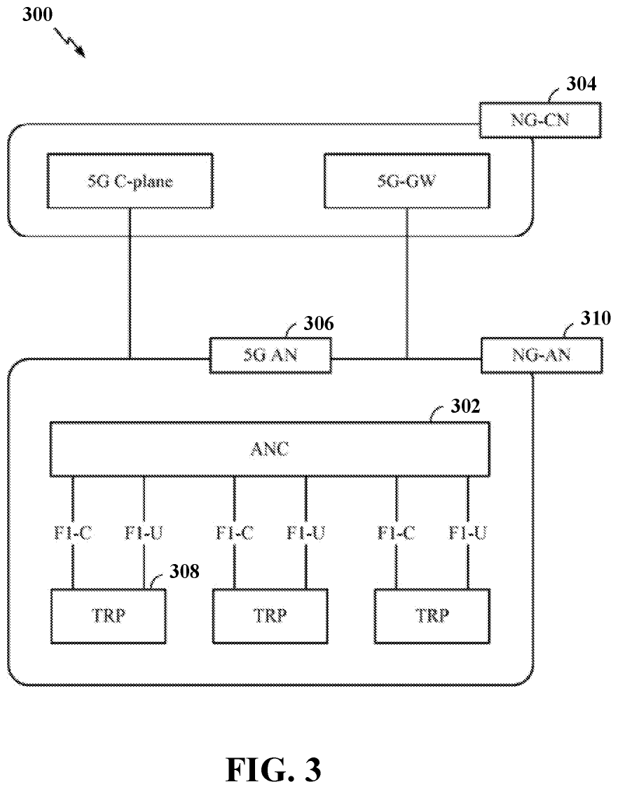

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

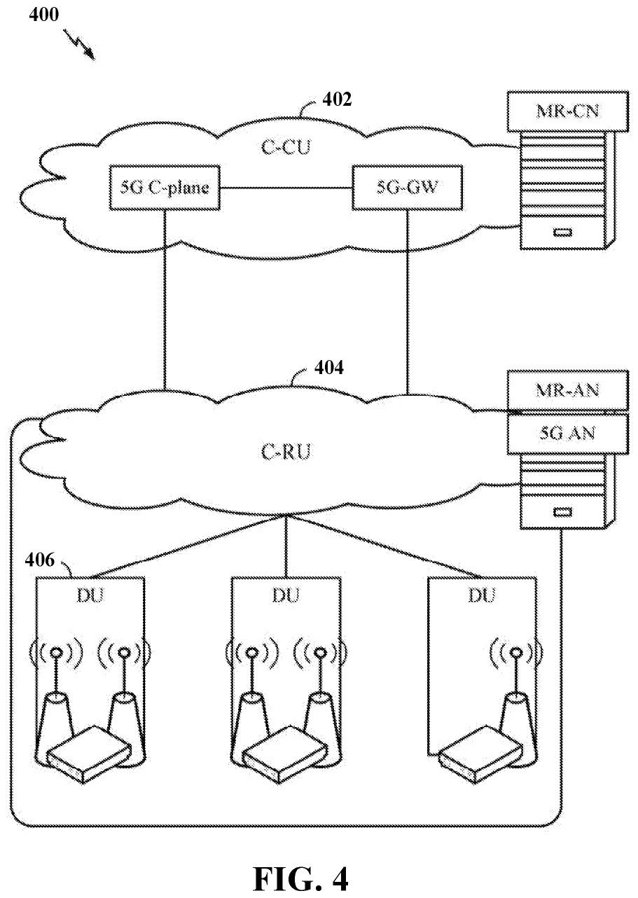

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

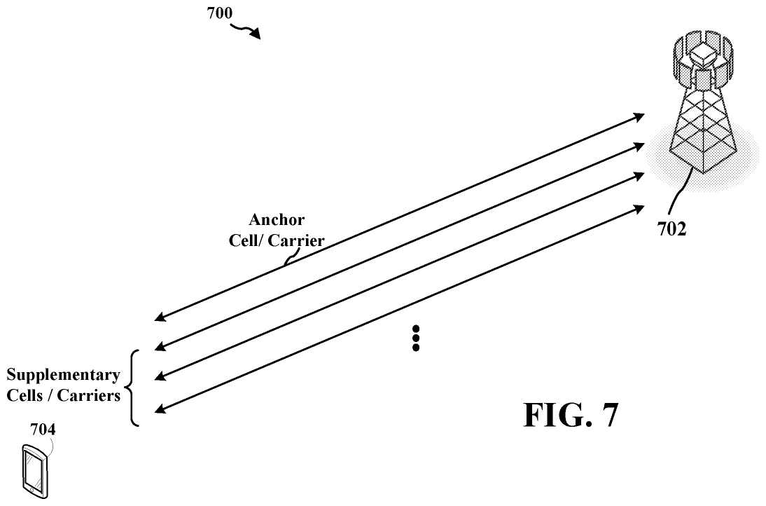

FIG. 7 is a diagram 700 illustrating a wireless communication system including a base station 702 and a UE 704. The wireless communication system implements an advanced carrier switch mechanism to optimize resource utilization between the base station 702 and the UE 704. This mechanism allows for a more flexible and efficient use of carriers, addressing scenarios where the number of configured carriers can exceed the UE's capability.

In this system, the network, through Radio Resource Control (RRC) signaling, may configure a set of carriers for the UE 704 to use for data transmission and reception. Notably, this configuration can surpass the UE's actual capability in terms of the total number of carriers it can simultaneously utilize. For instance, the RRC might configure two 100 MHz carriers for a UE 704 that is only capable of handling one 100 MHz carrier at a time. This approach provides the network with greater flexibility in resource allocation.

Given the limitation of the UE's capability, only a subset of the configured carriers is activated at any given time for downlink (DL) or uplink (UL) transmission. The number of activated carriers remains within the UE's capability. When a carrier is activated, it becomes available for both DL reception and UL transmission for the duration it remains active.

The carrier switch process refers to the dynamic changing of activated carriers for the UE 704, aiming to optimize resource utilization. Two primary mechanisms facilitate this carrier switch:
1. Semi-static pattern: This approach involves configuring the carrier switch at a higher layer, typically through RRC signaling. The pattern defines when and how carriers are to be switched and remains relatively static over a particular period. While the semi-static switch allows for predictable and efficient resource allocation, it may not be agile enough to respond to rapidly changing network conditions.
2. Dynamic indication pattern: In contrast to the semi-static pattern, this approach uses lower-layer signaling, such as Downlink Control Information (DCI) at Layer 1, to inform the UE 704 about the need for a carrier switch. This method provides greater flexibility to adapt to changing network conditions but may require more signaling overhead.

The selection between semi-static and dynamic indication patterns for carrier switch depends on specific use cases or UE capabilities. The network may also employ a combination of both approaches to achieve an optimal balance between resource utilization and flexibility.

The carrier switch process includes a switch gap. This gap facilitates a smooth transition between carriers. The UE 704 reports its capability regarding the length of the switch gap, enabling the base station 702 to set its configurations accordingly. The UE's capability report can specify whether the same switch gap length applies to both receive unit (RxU) and transmit unit (TxU) switch or if different lengths are required.

In addition to configuring the carrier switch pattern, the base station 702 may configure the specific length and timing of the switch gap through UE-specific RRC signaling. This approach allows for individual optimization of each UE based on its unique capabilities. Similar to the UE's capability report, the network may configure distinct values for RxU and TxU switch.

The implementation of carrier switch with adaptive switch gap management may enhance peak throughput by minimizing interruptions to data transmission during the switch process. By controlling the switch gap length and timing, the network can optimize the utilization of available resources, resulting in increased data rates for both DL and UL traffic.

Furthermore, the reduction in switch-related latency contributes to an overall improvement in data latency. The optimized carrier switch also allows the network to expand its coverage area and effectively offload data traffic, improving overall network performance.

This carrier switch mechanism is beneficial in scenarios with multiple Time Division Duplex (TDD) carriers with complementary configurations. For example, when one carrier is predominantly in downlink mode while another is in uplink mode, the UE 704 can switch between these carriers to maximize resource utilization. This approach prevents scenarios where UL or DL capabilities remain idle during opposing transmission modes.

The system also addresses various use cases, such as finding the best uplink or downlink scheduling opportunities, managing carrier load balancing, adapting to interference levels, and achieving MIMO gains. This flexibility marks a significant advancement over previous NR systems, where carrier switching was primarily limited to uplink transmissions for MIMO purposes.

In practice, the base station 702 may configure multiple carriers within a single cell, with one designated as the anchor carrier and others as supplementary carriers. The UE 704 can then switch between these carriers based on the configured patterns or dynamic indications. This setup allows for more efficient use of the UE's capabilities, as it can adapt to changing network conditions and requirements without being constrained by a fixed carrier assignment.

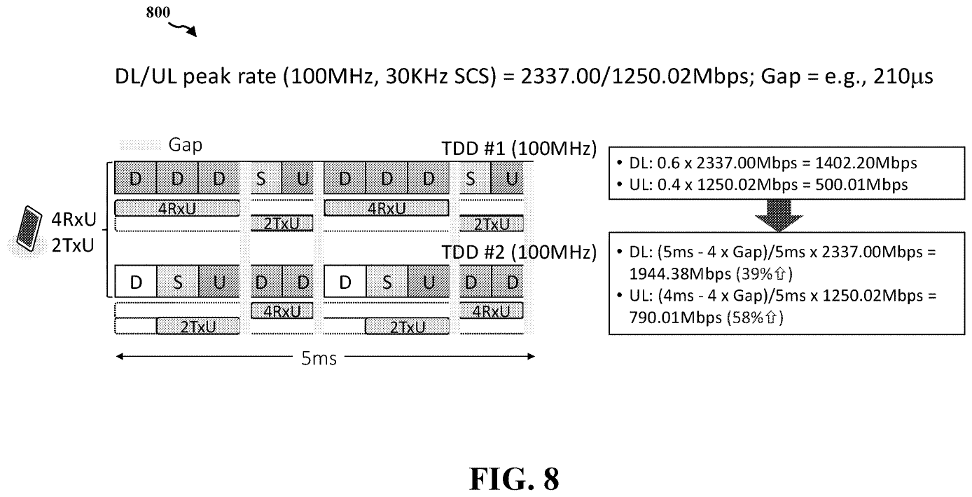

FIG. 8 is a diagram 800 illustrating an improved result of an agile carrier switch. In the illustrated scenario, when one carrier (e.g., TDD #1) is predominantly in the downlink mode, the other (e.g., TDD #2) is largely in the uplink mode. This complementary arrangement presents an opportunity for optimizing resource usage through carrier switching. Consider a UE 704 equipped with four receive units (RxUs) and two transmit units (TxUs). Without the ability to switch between carriers, the UE 704 would be confined to operate within a single TDD carrier. Consequently, during downlink slots, the UE's uplink capability would remain idle, and conversely, during uplink slots, the UE's downlink capabilities would be underutilized.

The agile carrier switch mechanism addresses this inefficiency by enabling the UE 704 to switch between carriers dynamically. This capability allows the UE 704 to optimally utilize both downlink and uplink slots across different carriers, thereby maximizing throughput gains. The base station 702 can leverage this flexibility to find the optimal scheduling opportunity for uplink or downlink transmissions, potentially based on current loading conditions.

Furthermore, the carrier switch mechanism facilitates more sophisticated network management strategies. For instance, the base station 702 may initiate a switch to carriers with lower loading, effectively balancing the network traffic. Additionally, the system can adjust based on interference levels to achieve MIMO (Multiple Input Multiple Output) gains and other performance enhancements.

The wireless communication system implements two frameworks to support carrier switch functionality, enhancing the flexibility and efficiency of resource utilization between the base station 702 and the UE 704. These frameworks address scenarios where the number of configured carriers can exceed the UE's capability, allowing for more dynamic and adaptive use of network resources.

The first framework is the SUL (Supplementary Uplink)/SDL (Supplementary Downlink)-based Framework. In this approach, a single cell incorporates multiple carriers: an anchor carrier and one or more supplementary carriers. The anchor carrier serves as the initial point of access for the UE 704 during the initial access procedure. Following the establishment of the connection, supplementary carriers are added or activated through higher layer signaling. This configuration differs significantly from traditional setups, where a cell typically includes a single downlink carrier and at most two uplink carriers.

Within the SUL/SDL-based framework, the anchor carrier and supplementary carrier(s) are similar to the Primary Cell (PCell) and additional carriers, respectively. The UE 704 can perform carrier switching between these carriers within the same cell. The TxRU (transmit/receive unit) sharing occurs across all carriers within the cell, effectively creating a pool of TxRUs that can be dynamically allocated. This sharing mechanism allows for more efficient resource utilization, as the UE 704 can switch between carriers to optimize performance based on current network conditions.

However, it is important to note that the UE 704 is not expected to perform transmission or reception on a carrier without available TxU (transmit unit) or RxU (receive unit) resources. This constraint helps maintain the integrity of the communication and prevents attempts to utilize unavailable resources.

The second framework is the CA (Carrier Aggregation)-based Framework. This approach involves an anchor cell, which functions similarly to a Primary Cell (PCell), and one or more supplementary cells, akin to Secondary Cells (SCells). As with the SUL/SDL-based framework, the anchor cell is the initial point of access for the UE 704, while supplementary cells are added or activated via higher layer signaling after the connection is established.

In the CA-based framework, TxRU sharing occurs across cells, not just within a single cell. This allows for even greater flexibility in resource allocation, as the UE 704 can switch between different cells to optimize resource utilization. However, similar to the SUL/SDL-based framework, the UE 704 is not expected to perform transmission or reception on a cell without available TxU or RxU resources.

While multiple cells may be configured, the actual number of active cells at any given time is limited by the UE's capability. This constraint necessitates intelligent management of cell activation and switching to maximize performance within the UE's limitations.

In wireless communication systems implementing carrier switch mechanisms, such as the one described involving the base station 702 and the UE 704, several challenges arise concerning the reception of Downlink Control Information (DCI) for broadcast messages, common messages, or scheduling information.

The Physical Downlink Control Channel (PDCCH) conveys control information from the base station 702 to the UE 704. Further, a search space defines the time-domain location where the UE 704 should monitor for PDCCH transmissions. It includes slot location, symbol position within a slot, and an associated Control Resource Set (CORESET) that specifies frequency domain resources and PDCCH symbols.

Search spaces have two types: Common Search Space (CSS) and UE-specific Search Space (USS). The CSS is for general scenarios such as system information reception, random access procedures, and paging, while the USS is for UE-specific receptions. These search spaces guide the UE 704 in performing blind detection of PDCCH in specific time-frequency resources, facilitating efficient discovery of control information.

However, in carrier switch scenarios, several issues can arise that prevent the UE 704 from successfully receiving DCI:
1. Overlap between PDCCH monitoring occasion and carrier switch occasion: When the timing of a carrier switch coincides with a scheduled PDCCH monitoring occasion, the UE 704 may be unable to monitor the PDCCH on either the original or the target carrier. This overlap can result in missed DCI, potentially leading to service interruptions or degraded performance.
2. Overlap between PDCCH monitoring occasion and carrier switch gap: As discussed earlier, carrier switches involve a switch gap to facilitate the transition between carriers. If a PDCCH monitoring occasion falls within this switch gap, the UE 704 will be unable to receive the DCI, as it is in the process of reconfiguring its receiver to the new carrier.
3. Lack of configured search space on the target carrier/cell: After switching to a new carrier, the UE 704 may find that there is no corresponding search space configured for the expected DCI. This scenario can occur if the network has not properly configured the search spaces on all potential target carriers, leaving the UE 704 unable to locate and decode the necessary control information.

These challenges are particularly critical for broadcast messages, which include essential network information such as system information updates, paging indications, and Random Access Channel (RACH) related information. The inability to receive these messages can severely impact the UE's ability to maintain synchronization with the network and respond to important events.

To address the challenges associated with carrier switching and PDCCH monitoring, particularly for broadcast messages, several solutions have been proposed. These solutions aim to maintain the UE's ability to receive critical broadcast information while accommodating the dynamic nature of carrier switching.

Broadcast PDCCH refers to PDCCH transmissions with Cyclic Redundancy Check (CRC) scrambled by specific Radio Network Temporary Identifiers (RNTIs). These include the System Information-RNTI (SI-RNTI) for system information broadcasts, the Paging-RNTI (P-RNTI) for paging and short messages, and the Random Access-RNTI (RA-RNTI) for RACH-related information. There is a need to maintain the reception of those broadcast messages during and after carrier switching events.

Three primary options have been proposed to manage broadcast PDCCH monitoring in carrier switch scenarios:
Option 1 proposes configuring search spaces for monitoring broadcast PDCCH on both the anchor carrier/cell and supplementary carrier(s)/cell(s). This approach utilizes various Common Search Space (CSS) types, including Type 0, Type 0A, Type 1, and Type 2. By implementing this option, the base station 702 provides the UE 704 with pre-configured search spaces on all potential carriers or cells to which it may switch. This pre-configuration allows the UE 704 to immediately begin monitoring for broadcast PDCCH on the new carrier or cell following a switch, using the search spaces configured via Radio Resource Control (RRC) signaling prior to the switch. Consequently, upon switching to a new carrier or cell, the UE 704 can adhere to the pre-established monitoring occasions for broadcast PDCCH, facilitating seamless reception of broadcast messages. This approach maximizes the likelihood of continuous reception of critical broadcast information, regardless of the active carrier or cell.
   Option 2 presents a simplified approach by configuring search spaces for monitoring broadcast PDCCH exclusively on the anchor carrier/cell. This method employs the same CSS types as Option 1 (Type 0, Type 0A, Type 1, and Type 2) but limits their configuration to the anchor carrier or cell. While this approach simplifies UE implementation, it introduces a potential drawback: when the UE 704 switches to a supplementary carrier or cell, it may temporarily lose the ability to monitor broadcast PDCCH messages. This limitation could result in the UE 704 missing important system information updates or other critical broadcast messages during its time on supplementary carriers or cells. The trade-off between simplicity and continuous broadcast reception must be carefully considered when implementing this option.
   Option 3 offers a hybrid approach, combining elements of both Option 1 and Option 2. In this configuration, search spaces for monitoring broadcast PDCCH associated with SI-RNTI and P-RNTI are configured only on the anchor carrier/cell, typically using Type 0, Type 0A, or Type 2 CSS. Conversely, search spaces for monitoring broadcast PDCCH associated with RA-RNTI are configured on both the anchor carrier/cell and supplementary carrier(s)/cell(s), often utilizing Type 1 CSS. This hybrid approach aims to balance implementation complexity with the need for continuous reception of critical broadcast messages. By selectively configuring search spaces based on the type of broadcast message, Option 3 provides a flexible solution that can adapt to various network environments and use cases. It allows the UE 704 to perform random access procedures across all available carriers while maintaining a simplified configuration for system information and paging messages on the anchor carrier/cell. However, similar to Option 2, this approach may result in the UE 704 missing system information updates or paging messages when switched to a supplementary carrier or cell.

The choice among these options depends on various factors, including network configuration, UE capabilities, and the specific requirements of the wireless communication system. Each option presents a unique balance between implementation complexity, resource utilization, and the continuity of broadcast message reception.

In scenarios where a Common Search Space (CSS) can only be configured on the anchor carrier/cell, such as for SI-RNTI or P-RNTI in Option 2 and Option 3 of the broadcast PDCCH monitoring solutions, additional handling becomes necessary to maintain the UE's ability to receive critical broadcast information. There are three primary options for managing these situations.
Option 1 introduces a mechanism for canceling the RxU switch under specific conditions. This approach aims to prevent the UE 704 from missing important broadcast PDCCH monitoring occasions. The cancellation occurs in two primary scenarios:

Firstly, when the RxU switch occasion collides with a PDCCH monitoring occasion of the search space, the UE 704 cancels the scheduled RxU switch. This collision typically occurs within the same slot. For example, if the UE 704 is scheduled to switch carriers in a particular slot based on the predetermined switch pattern, but this slot also contains a PDCCH monitoring occasion, the switch is canceled. The UE 704 then remains on its current carrier until the next switch opportunity arises according to the switch pattern.

Secondly, the UE 704 cancels the RxU switch if the duration of “no available RxU” overlaps with one or multiple PDCCH monitoring occasions of the search space. This scenario addresses collisions that may occur across different slots. For instance, if the UE 704 is scheduled to switch carriers in the third slot, but its PDCCH monitoring duty falls in the fourth slot, resulting in a period without an available RxU that overlaps with the monitoring occasion, the switch is canceled. The absence of an available RxU may result from various factors, including being in a switch gap or having switched to another carrier.

To minimize service interruption, it is preferable that the cancellation does not occur during the first three OFDM symbols of a slot, as these symbols often carry critical control information.
Option 2 proposes a more dynamic approach to RxU switching. In this option, the UE 704 performs an RxU switch specifically for PDCCH monitoring. After receiving the last symbol of the corresponding Physical Downlink Shared Channel (PDSCH), the UE 704 resumes its original RxU switching pattern. This approach allows the UE 704 to temporarily deviate from its predetermined switch pattern to receive important broadcast information.

For example, consider a scenario where the UE 704 switches to a supplementary carrier in slot 1, but a PDCCH monitoring occasion is scheduled on the anchor carrier in slot 3. Under normal circumstances, the UE 704 would not switch back to the anchor carrier based on its switch pattern. However, with this option, the UE 704 performs an additional switch to the anchor carrier for the PDCCH monitoring occasion in slot 3. After receiving the complete PDSCH associated with the broadcast PDCCH (which may extend beyond slot 3), the UE 704 then reverts to its original switching pattern.
Option 3 presents a straightforward approach where the UE 704 monitors the PDCCH of the search space only when an RxU is available on the relevant carrier. This option accepts the possibility of missing some broadcast messages, operating under the assumption that the base station 702 is aware of the UE's monitoring limitations due to carrier switching. In this scenario, if monitoring is skipped due to the unavailability of an RxU, it is considered an acceptable outcome, albeit with the understanding that some messages may be missed.

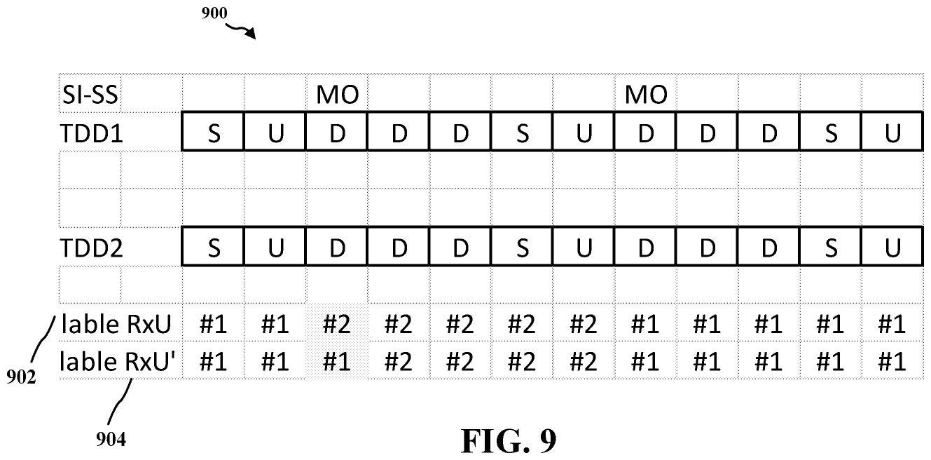

FIG. 9 is a diagram 900 illustrating an example of canceling an RxU switch. The diagram depicts two RxU switching patterns: pattern 902 represents the configured RxU pattern, while pattern 904 shows the actual RxU pattern. In this example, a collision occurs in slot 3, prompting the cancellation of the UE 704's switch from carrier 1 to carrier 2. Consequently, the UE 704 remains on carrier 1. To minimize service interruption, it is preferable for any interruption to avoid occurring during the first three OFDM symbols of a slot, as these symbols often carry critical control information.

The cancellation mechanism illustrated in FIG. 9 is part of Option 1 for managing situations where Common Search Space (CSS) is configured only on the anchor carrier/cell. This approach aims to prevent the UE 704 from missing important broadcast PDCCH monitoring occasions. The cancellation is triggered under two primary conditions: when the RxU switch occasion collides with a PDCCH monitoring occasion of the search space, or when the duration of “no available RxU” overlaps with one or multiple PDCCH monitoring occasions of the search space.

During a link recovery procedure, the wireless communication system implements a specific protocol to prevent potential disruptions caused by carrier switching. When the UE 704 initiates a link recovery procedure, any scheduled TxRU (transmit/receive unit) carrier switch is temporarily suspended. This suspension remains in effect until the link recovery procedure is fully completed. Specifically, the TxRU does not switch carriers within the window designated for PDCCH (Physical Downlink Control Channel) monitoring, as defined by the parameter “recoverySearchSpaceId”. This approach minimizes the risk of further connection instability during the critical phase of link recovery.

The implementation of this measure requires coordination between the base station 702 and the UE 704. The base station 702 needs to be aware of the UE's link recovery status to appropriately manage scheduled carrier switches. Similarly, the UE 704 needs to prioritize the link recovery procedure over any pre-configured carrier switch patterns. This coordination helps maintain the integrity of the communication link during periods of potential instability.

While the previously discussed methods primarily focus on obtaining information for the anchor carrier or cell, the wireless communication system also provides mechanisms for acquiring system information updates for supplementary carriers or cells. These mechanisms are useful for maintaining up-to-date information across all active carriers, enabling efficient resource utilization and optimal performance. The system offers three primary options for obtaining these updates:

The first option utilizes dedicated signaling, typically in the form of dedicated Radio Resource Control (RRC) signaling. In this approach, the base station 702 transmits specific RRC messages to the UE 704, containing the necessary system information updates for the supplementary carriers or cells. This method allows for targeted delivery of information, reducing overhead in scenarios where only certain UEs require updates for specific supplementary carriers.

The second option involves transmitting a new System Information Block (SIB), referred to as SIBx, on the anchor carrier or cell. This SIB is specifically designed to carry system information related to the supplementary carriers or cells. By consolidating this information on the anchor carrier, the system reduces the complexity of monitoring multiple carriers for updates. The UE 704 can acquire the necessary information for all associated supplementary carriers or cells by monitoring a single carrier, thereby optimizing resource usage and potentially reducing power consumption.

The third option entails transmitting System Information Block Type 1 (SIB1) directly on the supplementary carriers or cells. In this scenario, each supplementary carrier or cell broadcasts its own SIB1, containing the relevant system information for that specific carrier or cell. This approach allows for more granular control of system information and may be beneficial in scenarios where supplementary carriers have significantly different characteristics or configurations.

To facilitate the reception of these system information updates, the UE 704 employs specific monitoring strategies. For options involving SIB transmission (either SIBx on the anchor carrier or SIB1 on supplementary carriers), the UE 704 monitors the search space for PDCCH with Cyclic Redundancy Check (CRC) scrambled by the Paging-Radio Network Temporary Identifier (P-RNTI). This monitoring allows the UE 704 to detect indications of system information updates.

Additionally, for the option where SIB1 is transmitted on supplementary carriers or cells, the UE 704 also monitors the search space for PDCCH with CRC scrambled by the System Information-Radio Network Temporary Identifier (SI-RNTI). Upon detecting the appropriate PDCCH, the UE 704 proceeds to read the corresponding Physical Downlink Shared Channel (PDSCH) or SIB1 on the relevant supplementary carrier or cell.

Further, the wireless communication system delivers common messages to multiple UEs simultaneously through group-UE-specific Physical Downlink Control Channel (PDCCH). This approach utilizes Downlink Control Information (DCI) formats, such as format 2-x, to convey group-wise information including slot format indications and power control information.

The configuration for monitoring group-UE-specific PDCCH allows it to be established on both the anchor carrier/cell and supplementary carriers/cells. In carrier switching scenarios, the UE 704 may frequently transition between different carriers. The search space for monitoring, exemplified by Type 3 Common Search Space (CSS), is not confined to the anchor carrier/cell but can also be configured on supplementary carrier(s)/cell(s). This expanded configuration capability enables the UE 704 to maintain consistent access to group-specific information across all active carriers.

In practice, the UE 704 monitors the group-UE-specific PDCCH on the active carrier/cell, which is defined as the carrier with an available Receive Unit (RxU). The determination of which carrier to monitor is guided by the corresponding configuration or indication, such as the carrier switch pattern or dynamic indications provided by the base station 702. The UE 704 to may receive group-specific information regardless of its current active carrier.

The system also incorporates a mechanism for cross-carrier or cross-cell information indication within the DCI formats. Certain DCI formats, such as DCI format 2-0 or 2-1, are designed to support this cross-referencing capability. In these cases, a carrier index is provided through UE-specific Radio Resource Control (RRC) signaling for configuration association. This feature enables a DCI received on one carrier/cell (e.g., carrier/cell 1) to provide relevant information for another carrier/cell (carrier/cell 2), enhancing the system's flexibility and efficiency in managing multi-carrier operations.

To facilitate the accurate interpretation of cross-carrier information, the system employs additional RRC signaling mechanisms. These signals instruct the UE 704 on how to parse the DCI format, particularly when it contains information relevant to multiple carriers. New RRC parameters, such as “carrierIndex,” may be introduced to serve this purpose. Alternatively, existing parameters like “servingCellId” may be repurposed with new interpretations to indicate which carrier a particular configuration is associated with. This approach allows for precise referencing of carrier-specific information within the DCI fields, enabling the UE 704 to correctly apply the received information across different carriers.

The wireless communication system implements a particular mechanism for UE-specific Physical Downlink Control Channel (PDCCH) monitoring, which allows for the configuration of UE-specific Search Spaces (USS) on both the anchor carrier/cell and supplementary carriers/cells.

When the UE 704 is configured for USS, it monitors the UE-specific PDCCH on the active carrier/cell in accordance with the corresponding configuration. The active carrier/cell is defined as the carrier or cell where the UE 704 currently has an available Receive Unit (RxU). The UE 704 can receive UE-specific control information regardless of which carrier it is currently operating on.

The process of carrier switching and subsequent PDCCH monitoring is dynamic and adaptive. Upon switching to a target carrier, the UE 704 begins monitoring the corresponding search space on that target carrier. This transition allows the UE 704 to maintain continuous reception of control information even as it moves between different carriers.

Further, despite being configured with multiple carriers or cells, the UE's capability in terms of PDCCH blind decoding number, the number of supported Control Resource Sets (CORESETs)/search spaces, and the Downlink Control Information (DCI) size budget remains consistent with that of a single-cell scenario. This approach is designed to maintain system efficiency and prevent excessive complexity in UE operations.

Specifically, the UE's capacity for these aspects does not increase proportionally with the number of configured carriers or cells. In practice, although the UE 704 may be configured with multiple carriers, during actual PDCCH monitoring and processing, it operates as if it were only operating on a single cell, adhering to the capability limits defined for single-cell operation.

The base station 702 maintains awareness of the UE's current active carrier. This awareness is facilitated by the predetermined carrier switch pattern or Layer 1 signaling that dictates the UE's carrier transitions. Consequently, when the base station 702 needs to transmit control information to the UE 704, it can target the specific carrier where the UE 704 is currently active. This targeted approach prevents unnecessary transmissions on inactive carriers, thereby improving overall system efficiency.

The UE 704 determines which carrier to switch to based on its predefined switch pattern or Layer 1 occasions. The network can effectively locate and communicate with the UE 704, even as it moves between different carriers. The switch pattern may be configured semi-statically through higher layer signaling or dynamically indicated through lower layer signaling, providing flexibility to adapt to changing network conditions.

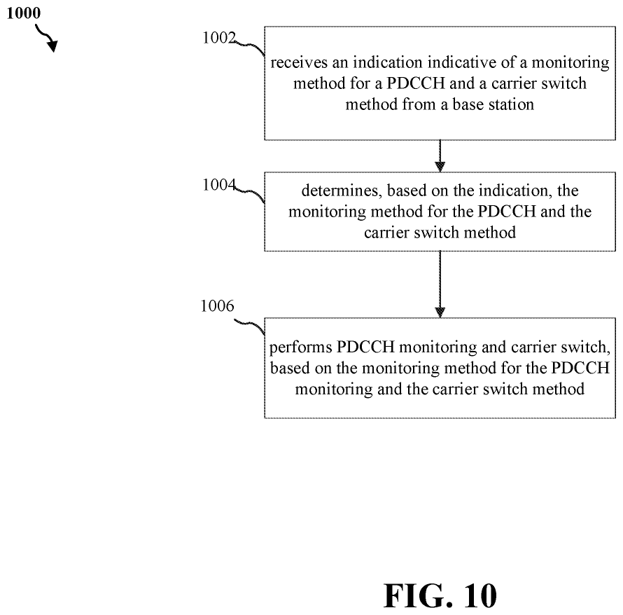

FIG. 10 illustrates a flow chart 1000 of a process for managing PDCCH monitoring in carrier switch scenarios. This process involves interactions between a network (NW) and a UE (e.g., the UE 704) through a base station (e.g., the base station 702).

At block 1002, the UE 704 receives an indication indicative of a monitoring method for a PDCCH and a carrier switch method from a base station 702. This indication may optimize the management of PDCCH monitoring in carrier switch scenarios, as it instructs the UE 704 how to perform its tasks for the PDCCH monitoring and carrier switch process. In some embodiments, the indication may be included in the parameters regarding search space configurations, semi-static carrier switch pattern configurations or dynamic carrier switch indications. The search space configurations may include monitored search space type, monitored DCI format, and monitoring occasion.

At block 1004, the UE 704 determines, based on the indication, the monitoring method for the PDCCH and the carrier switch method. In some embodiments, the PDCCH monitoring may include a broadcast PDCCH monitoring, a group-UE-specific PDCCH monitoring or a UE-specific PDCCH monitoring. For the broadcast PDCCH monitoring, the search space may be configured on both an anchor carrier and one or more supplementary carriers, or configured on an anchor carrier. In some embodiments, the search space may include: monitoring a PDCCH whose CRC is scrambled by a SI-RNTI, monitoring a PDCCH whose CRC is scrambled by a RA-RNTI, or monitoring a PDCCH whose CRC is scrambled by a P-RNTI.

The search space may also be configured based on the type of the broadcast PDCCH monitoring. For example, a search space for a first type of the broadcast PDCCH monitoring may be configured on both an anchor carrier and one or more supplementary carriers, and a search space for a second type of the broadcast PDCCH monitoring may be configured on the anchor carrier. In some embodiments, the first type of the broadcast PDCCH monitoring may include monitoring a PDCCH whose CRC is scrambled by a RA-RNTI, and the second type of the broadcast PDCCH monitoring may include monitoring a PDCCH whose CRC is scrambled by a SI-RNTI or a P-RNTI.

When a search space for the broadcast PDCCH monitoring is configured on an anchor carrier and a predetermined condition is met, a DL carrier switch of a predefined DL carrier switch pattern may be canceled until the next DL carrier switch occasion of the predetermined DL carrier switch pattern. In some embodiments, the predetermined condition may include: a DL carrier switch occasion colliding with a PDCCH monitoring occasion of the search space, or a duration when the DL carrier is not active colliding with one or multiple PDCCH monitoring occasions of the search space.

The UE 704 may also perform an additional DL carrier switching for the broadcast PDCCH monitoring and resumes an original DL carrier switching pattern after receiving a last symbol of a corresponding PDSCH for the broadcast PDCCH monitoring. Furthermore, the UE 704 may monitor a PDCCH of a search space for the broadcast PDCCH monitoring when the carrier with the PDCCH monitoring occasion is active. In addition, during a link recovery procedure, a carrier switch is pending until the link recovery procedure is finished.

In some embodiments, system information update of the one or more supplementary carriers may be obtained via a dedicated signaling, a designated SIB transmitted on the anchor carrier, or a SIB Type 1 (SIB1) transmitted on the one or more supplementary carriers.

In some embodiments, a search space for the group-UE-specific PDCCH monitoring may be configured on both an anchor carrier and one or more supplementary carriers. The UE may perform the group-UE-specific PDCCH monitoring on an active carrier according to a corresponding configuration or indication. For a DCI format supporting a cross-carrier information indication, a RRC parameter may be configured to indicate a target carrier with which the corresponding configuration or indication is associated.

In some embodiments, a search space for the UE-specific PDCCH monitoring may be configured on both an anchor carrier and one or more supplementary carriers. For the UE-specific PDCCH monitoring, a capability of the UE 704 on a PDCCH blind decoding number, a number of supported CORESETs or search spaces, and a DCI size budget may present a capability for a single cell.

Following the the determination of the monitoring method for the PDCCH and the carrier switch method, at block 1006, the UE 704 performs PDCCH monitoring and carrier switch, based on the monitoring method for the PDCCH monitoring and the carrier switch method, thereby maintaining the ability of the UE 704 to receive critical broadcast information while accommodating the dynamic nature of carrier switching.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving an indication indicative of a monitoring method for a physical downlink control channel (PDCCH) and a carrier switch method from a base station;
determining, based on the indication, the monitoring method for the PDCCH and the carrier switch method; and
performing PDCCH monitoring and carrier switch, based on the monitoring method for the PDCCH monitoring and the carrier switch method.

2. The method of claim 1, wherein the PDCCH monitoring comprises a broadcast PDCCH monitoring, a group-UE-specific PDCCH monitoring or a UE-specific PDCCH monitoring.

3. The method of claim 2, wherein a search space for the broadcast PDCCH monitoring is configured on both an anchor carrier and one or more supplementary carriers.

4. The method of claim 3, wherein the search space for the broadcast PDCCH monitoring comprises: monitoring a PDCCH whose cyclic redundancy check (CRC) is scrambled by a system information-radio network temporary identifier (SI-RNTI), monitoring a PDCCH whose CRC is scrambled by a random access-RNTI (RA-RNTI), or monitoring a PDCCH whose CRC is scrambled by a paging-RNTI (P-RNTI).

5. The method of claim 2, wherein a search space for the broadcast PDCCH monitoring is configured on an anchor carrier.

6. The method of claim 5, wherein the search space for the broadcast PDCCH monitoring comprises: monitoring a PDCCH whose cyclic redundancy check (CRC) is scrambled by a system information-radio network temporary identifier (SI-RNTI), monitoring a PDCCH whose CRC is scrambled by a random access-RNTI (RA-RNTI), or monitoring a PDCCH whose CRC is scrambled by a paging-RNTI (P-RNTI).

7. The method of claim 2, wherein a search space for a first type of the broadcast PDCCH monitoring is configured on both an anchor carrier and one or more supplementary carriers, and a search space for a second type of the broadcast PDCCH monitoring is configured on the anchor carrier.

8. The method of claim 7, wherein the first type of the broadcast PDCCH monitoring comprises monitoring a PDCCH whose cyclic redundancy check (CRC) is scrambled by a random access-radio network temporary identifier (RA-RNTI).

9. The method of claim 7, wherein the second type of the broadcast PDCCH monitoring comprises monitoring a PDCCH whose cyclic redundancy check (CRC) is scrambled by a system information-radio network temporary identifier (SI-RNTI) or a paging-RNTI (P-RNTI).

10. The method of claim 2, wherein when a search space for the broadcast PDCCH monitoring is configured on an anchor carrier and a predetermined condition is met, a downlink (DL) carrier switch of a predefined DL carrier switch pattern is canceled until the next DL carrier switch occasion of the predetermined DL carrier switch pattern.

11. The method of claim 10, wherein the predetermined condition comprises: a DL carrier switch occasion colliding with a PDCCH monitoring occasion of the search space, or a duration when the DL carrier is not active colliding with one or multiple PDCCH monitoring occasions of the search space.

12. The method of claim 2, wherein the UE performs an additional downlink (DL) carrier switching for the broadcast PDCCH monitoring and resumes an original DL carrier switching pattern after receiving a last symbol of a corresponding physical downlink shared channel (PDSCH) for the broadcast PDCCH monitoring.

13. The method of claim 2, wherein the UE monitors a PDCCH of a search space for the broadcast PDCCH monitoring when the carrier with the PDCCH monitoring occasion is active.

14. The method of claim 2, wherein during a link recovery procedure, a carrier switch is pending until the link recovery procedure is finished.

15. The method of claim 3, wherein system information update of the one or more supplementary carriers is obtained via a dedicated signaling, a designated system information block (SIB) transmitted on the anchor carrier, or a SIB Type 1 (SIB1) transmitted on the one or more supplementary carriers.

16. The method of claim 2, wherein a search space for the group-UE-specific PDCCH monitoring is configured on both an anchor carrier and one or more supplementary carriers.

17. The method of claim 16, wherein the UE performs the group-UE-specific PDCCH monitoring on an active carrier according to a corresponding configuration or indication.

18. The method of claim 17, wherein for a downlink control information (DCI) format supporting a cross-carrier information indication, a radio resource control (RRC) parameter is configured to indicate a target carrier with which the corresponding configuration or indication is associated.

19. The method of claim 2, wherein a search space for the UE-specific PDCCH monitoring is configured on both an anchor carrier and one or more supplementary carriers.

20. The method of claim 19, wherein for the UE-specific PDCCH monitoring, a capability of the UE on a PDCCH blind decoding number, a number of supported control resource sets (CORESETs) or search spaces, and a downlink control information (DCI) size budget presents a capability for a single cell.

21. An apparatus for wireless communication, the apparatus being a user equipment (UE), comprising:
a memory; and
at least one processor coupled to the memory and configured to:
receive an indication indicative of a monitoring method for a physical downlink control channel (PDCCH) and a carrier switch method from a base station;
determine, based on the indication, the monitoring method for the PDCCH and the carrier switch method; and
perform PDCCH monitoring and carrier switch, based on the monitoring method for the PDCCH monitoring and the carrier switch method.

22. A computer-readable medium storing computer executable code for wireless communication of a user equipment (UE), comprising code to:
receive an indication indicative of a monitoring method for a physical downlink control channel (PDCCH) and a carrier switch method from a base station;
determine, based on the indication, the monitoring method for the PDCCH and the carrier switch method; and
perform PDCCH monitoring and carrier switch, based on the monitoring method for the PDCCH monitoring and the carrier switch method.
